(19) United States
(12) Patent Application Publication
(10) Pub. No.: US 2017/0076309 A1
(43) Pub. Date: Mar. 16, 2017

(54) Systems and Methods for Use in Linking Discounts for Product Purchases to Social Networks

(71) Applicant: MASTERCARD INTERNATIONAL INCORPORATED, Purchase, NY (US)

(72) Inventors: Joshua J. Baron, St. Louis, MO (US); Timothy R. Zyk, St. Louis, MO (US); Deborah J. Shell, St. Louis, MO (US); Ellen C. Heitman, St. Louis, MO (US); Joshua G. Monroe, Wentzville, MO (US)

(21) Appl. No.: 14/923,906

(22) Filed: Oct. 27, 2015

Related U.S. Application Data
(60) Provisional application No. 62/217,481, filed on Sep. 11, 2015.

(51) Int. Cl. G06Q 30/02; G06Q 50/00

(52) U.S. Cl. CPC G06Q 30/0214; G06Q 50/01

(57) ABSTRACT

Systems and methods are provided for linking product offerings with social network content. One exemplary method includes verifying, by a computing device, via an application programming interface (API) associated with the social network, a social network action, by a consumer, for a product in a social network, and awarding a discount to the consumer for the product, when the social network action is verified, whereby the consumer is able to purchase the product for the price of the product less the awarded discount. Often, the social network action is a “like” of the product, whereby a social network content associated with the product is then disseminated to at least one follower of the consumer in the social network in response to the action.

### CROSS-REFERENCE TO RELATED APPLICATION

This application claims the benefit of, and priority to, U.S. Provisional Application No. 62/217,481 filed on Sep. 11, 2015. The entire disclosure of the above application is incorporated herein by reference.

### FIELD

The present disclosure generally relates to systems and methods for linking discounts for product purchases to social network actions and, in particular, to permitting merchant campaigns by which consumers are given discounts for products in exchange for actions at certain social networks.

### BACKGROUND

This section provides background information related to the present disclosure which is not necessarily prior art.

Consumers use payment accounts to purchase various different products (e.g., good and services, etc.). The products may be purchases through websites, or other web-based store fronts, associated with one or more merchants. In general, merchants rely on rebates, discounts, and sales, for the purchases of products at the web-based store fronts to, in combination with various forms of advertising, entice consumers to purchase the products from the web-based store fronts. Separately, social networks are known to include a variety of users, which have interests in various different things, including products. The social network users are known to “like” or “dislike” certain content in the social network, thereby denoting their approval, disapproval, endorsement, or dissatisfaction with the content.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in linking product discounts to social network actions as part of social network campaigns;

FIG. 2 is a block diagram of a computing device, that may be used in the exemplary system of FIG. 1;

FIG. 3 is an exemplary interface, which may be displayed to a merchant in connection with the system of FIG. 1 and/or the method of FIG. 4, for compiling a social network campaign for a product;

FIG. 4 is an exemplary method for linking a discount for the purchase of a product, by a consumer, to a social network action by the consumer in connection with a social network campaign by a merchant, that may be implemented in the system of FIG. 1;

FIG. 5 is an exemplary interface, which may be displayed to a consumer in connection with the system of FIG. 1 and/or the method of FIG. 4, for purchasing a product from a merchant, with the option to receive a social network discount as part of a social network campaign;

FIG. 6 is exemplary interfaces, which may be displayed to the consumer in connection with the interface of FIG. 5, for purchasing the product from the merchant;

FIG. 7 is exemplary interfaces, which may be displayed to the consumer in connection with the interface of FIG. 6, for receiving the consumer's social network credentials;

FIG. 8 is exemplary interfaces, which may be displayed to the consumer in connection with the interface of FIG. 5, for purchasing the product from the merchant; and

FIG. 9 is an exemplary interface, which may be displayed to a merchant in connection with the system of FIG. 1 and/or the method of FIG. 4, for providing a social network campaign status to the merchant.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Products (e.g., goods and/or services, etc.) are often purchased through virtual store fronts (broadly, sales platforms), and are offered for sale by merchants through websites, web-based applications, etc. The prices associated with the products may be discounted, for example, when merchants offer sales, or otherwise seek to encourage consumers to purchase the products. Uniquely, the systems and methods herein offer discounts for products, when consumers “like” the products (or otherwise perform particular social network actions), at one or more social networks. In particular, the products are offered for sale through sales platforms associated with the merchants (e.g., at websites, etc.), at which the consumers are able to log into one or more social networks and “like” the products. In turn, the “likes” are confirmed, and the discounts are applied immediately for the consumers to purchases of the products at the sales platforms. In this manner, the products are proliferated through the social network(s) to the followers of the consumers (based on the social network “likes” or other actions) and other potential consumers, who are in turn notified of and/or otherwise view the consumers' “likes” for the products. As additional social network followers (of the consumers) purchase the products (from links, for example, included in the liked posts), at the discounted prices, the merchants achieve efficient marketing of the products through the consumers' social network actions (e.g., “likes” of the products, etc.).

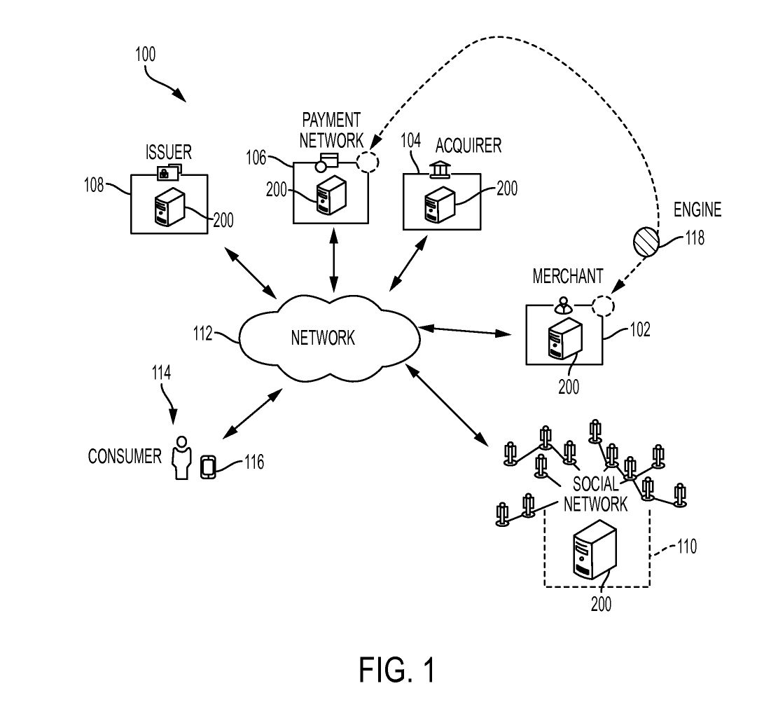

FIG. 1 illustrates an exemplary system 100, in which the one or more aspects of the present disclosure may be implemented. Although the system 100 is presented in one arrangement, other embodiments may include the parts of the system (or other parts) arranged otherwise depending on, for example, web-based interfaces used for offering products for sale, and/or manners of awarding discounts, verifying social network actions, and/or processing transactions to consumer payment accounts, etc.

The system 100 generally includes a merchant 102, an acquirer 104, a payment network 106, an issuer 108, and a social network 110, each coupled to (and in communication with) network 112. The network 112 may include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. For example, network 112 may include multiple different networks, such as a private payment transaction network made accessible by the payment network 106 to the acquirer 104 and the issuer 108 and, separately, the public Internet, which may provide interconnection between the merchant 102, the payment network 106, the social network 110 and a consumer 114 (or a consumer's communication device 116), etc.

The merchant 102 is generally associated with products (e.g., goods and/or services, etc.) for purchase by one or more consumers (e.g., consumer 114, etc.). In the illustrated system 100, the products are offered for sale through a virtual store front (broadly, a sales platform), which may be offered and/or hosted by the merchant 102, or another part of the system 100. For example, the payment network 106 may offer a sales platform, as a service to merchant 102, especially if merchant 102 is smaller in scale and/or of insufficient size to generate and/or manage a merchant-specific sales platform. In this embodiment, the sales platform is provided in the form of a website, which is hosted by the payment network 106, through which the merchant 102 is able to offer products for sale. In other embodiments, the sales platform may include a website hosted by the merchant 102, or by a third party associated with the merchant 102. In still other embodiments, the sales platform may cooperate with a companion web-based application, which is installable at a communication device (e.g., a smartphone, tablet, communication device 116 associated with consumer 114, etc.) through which consumers are able to view and/or purchase product(s) from the merchant 102. It should be appreciated that any other types of web-based platforms, hosted and/or provided by the merchant 102, the payment network 106, or another part of system 100, or other part (not shown), may be employed herein, whereby the consumer 114 is permitted to view and/or purchase one or more products from the merchant 102, etc.

With continued reference to FIG. 1, the consumer 114 is associated with a payment account (or with multiple payment accounts) through which the consumer 114 is able to cause payment account transactions for products (e.g., for products offered for sale by the merchant 102, etc.).

In connection with a transaction between the consumer 114 and the merchant 102, for example, for the purchase of a product, a payment device associated with the consumer 114 (and the consumer's payment account), or payment account information associated therewith, is presented to the merchant 102, via the merchant's virtual store front. In turn, the merchant 102 submits an authorization request to the acquirer 104 for the transaction. The authorization request may include, for example, a payment account number (e.g., PAN, etc.), an amount of the transaction, a merchant ID, and/or additional information as desired and/or as necessary to process the transaction, etc. The acquirer 104 then communicates the authorization request to the issuer 108, through the payment network 106, such as, for example, through MasterCard®, VISA®, Discover®, American Express®, etc., to determine (by the issuer 108) whether the payment account is in good standing and whether there is sufficient credit and/or funds to complete the transaction. If the issuer 108 accepts the transaction, a reply authorizing the transaction is provided back to the acquirer 104 and the merchant 102, thereby permitting the merchant 102 to complete the transaction. The transaction is later cleared and/or settled by and between the merchant 102 and the acquirer 104 (via an agreement between the merchant 102 and the acquirer 104), and by and between the acquirer 104 and the issuer 108 (via an agreement between the acquirer 104 and the issuer 108) (through further communication therebetween). If the issuer 108 declines the transaction, however, a reply declining the transaction is provided back to the merchant 102, thereby permitting the merchant 102 to terminate the transaction.

Transaction data is generated, collected, and stored as part of the above interactions among the merchant 102, the acquirer 104, the payment network 106, the issuer 108, and the consumer 114. The transaction data represents at least a plurality of transactions, for example, authorized transactions, cleared and/or settled transactions, attempted transactions, etc. The transaction data, in this exemplary embodiment, is stored at least by the payment network 106 (e.g., in a data structure associated with the payment network 106, etc.). Additionally, or alternatively, the merchant 102, the acquirer 104 and/or the issuer 108 may store the transaction data, or part thereof, in a data structure, or transaction data may be transmitted between parts of system 100, as used or needed. The transaction data may include, for example, payment account numbers, amounts of the transactions, merchant IDs, merchant category codes (MCCs), dates/times of the transactions, products purchased and related descriptions or identifiers, etc.

In various exemplary embodiments, the consumers (e.g., consumer 114, etc.) involved in the different transactions herein are prompted to agree to legal terms associated with their payment accounts, for example, during enrollment in their accounts, etc. In so doing, the consumers may voluntarily agree, for example, to allow merchants, issuers, payment networks, etc., to use data collected during enrollment and/or collected in connection with processing the transactions, subsequently for one or more of the different purposes described herein.

Referring still to FIG. 1, the social network 110 of the system 100 may, in general, include any website or other medium, through which a user is permitted to post content or comments to forums and/or profiles, send messages, and/or otherwise facilitate communication with one or more other users, who are either linked or not linked to the user. Social networks may include, for example, Twitter®, Facebook®, LinkedIn®, Google+®, YouTube®, Instagram®, Pinterest®, other socially directed environments, or combinations thereof, etc. In various social networks, users include consumers, (e.g., consumer 114), who post social content about products to be purchased or previously purchased, and/or who review social content about products posted by other users/consumers. In particular in the system 100, the content may be posted, by the consumer 114 or by other consumers, to a social network profile associated with the consumer 114. As such, the social network 110 generally defines a mass of social network data, which may be specific to consumer 114, and/or general to other consumers, who are linked or not linked to the consumer 114. The other consumers are then further linked, or not linked, within the social network 110 (and potentially within other social networks) to one another. Social network data may include, for example, consumer comments about impending purchases of a product and/or about merchant 102 (or other merchants), “likes” or “dislikes” of products, “likes” or “dislikes” of merchants (e.g., merchant 102), etc. (all broadly, social network actions). In general, and as conventionally understood, a “like” indicates the consumer's approval, satisfaction and/or endorsement of corresponding social media content, while a “dislike” indicates disapproval, dissatisfaction and/or warning of the content.

For purposes of illustration herein, the consumer 114 maintains an account with the social network 110, and is linked to multiple other ones of the users of the social network 110, such that when the consumer 114 “likes” social network content (broadly, takes a social network action), the multiple other users are alerted to and/or informed of the consumer's action, often with a copy of the action (e.g., a copy of the content “liked” by the consumer 114, etc.). It should be appreciated that a variety of variations to the “like” or “dislike” actions to the social network 110 (and their effects), as described herein, may be included in other embodiments, as different social networks may behave in different manners (e.g., other social networks may include actions such as a thumb up for approval and a thumb down for disproval, etc.).

Moreover, in the system 100, the social network 110 is configured with one or more application programming interfaces, or APIs, made available through network 112. The APIs enable one or more third parties (e.g., the payment network 106, the merchant 102, both, etc.), given the proper permissions, to access social network data for the social network 110. The access provided by the APIs is specific to a consumer in the system 100 (e.g., consumer 114), whereby the third parties are able to efficiently retrieve, view and/or verify certain social media content associated with the consumer. In particular, the payment network 106 and/or the merchant 102, for example, given the proper permissions, is able to verify that the consumer 114 has or has not “liked” a particular product (or taken another particular action, ad described herein).

While one merchant 102, one acquirer 104, one payment network 106, one issuer 108, one social network 110, and one consumer 114, are illustrated in FIG. 1, it should be appreciated that any number of these parts (and their associated parts, including third parties) may be included in the system 100, or may be included as one or more parts of systems in other embodiments, consistent with the present disclosure.

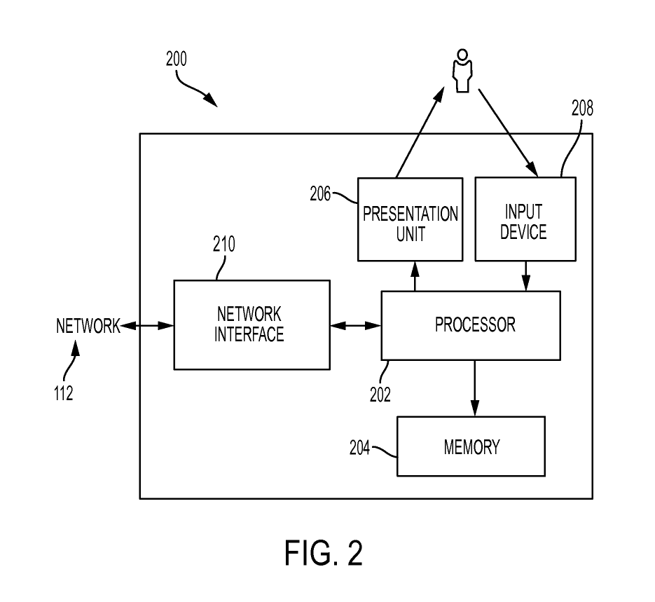

FIG. 2 illustrates an exemplary computing device 200 that can be used in the system 100. The computing device 200 may include, for example, one or more servers, workstations, personal computers, laptops, tablets, smartphones, PDAs, etc. In addition, the computing device 200 may include a single computing device, or it may include multiple computing devices located in close proximity or distributed over a geographic region, so long as the computing devices are specifically configured to function as described herein. However, the system 100 should not be considered to be limited to the computing device 200, as described below, as different computing devices and/or arrangements of computing devices may be used. In addition, different components and/or arrangements of components may be used in other computing devices.

In the exemplary embodiment of FIG. 1, each of the merchant 102, the acquirer 104, the payment network 106, the issuer 108, and the social network 110 are illustrated as including, or being implemented in, computing device 200, coupled to the network 112. Further, the computing devices 200 associated with these parts, for example, may include a single computing device, or multiple computing devices located in close proximity or distributed over a geographic region, again so long as the computing devices are specifically configured to function as described herein. In addition, the communication device 116, which is associated with consumer 114, can also be considered a computing device consistent with computing device 200 for purposes of the description herein. In particular, in this exemplary embodiment, the communication device 116 is a portable communication device, such as, for example, a smartphone, a tablet, a laptop, etc.,

Referring to FIG. 2, the exemplary computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic circuit (PLC), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, social network campaigns by merchants, consumer credentials, merchant credentials, data regarding products offered for sale by merchants, product purchase interfaces (e.g., webpages, etc.), payment account information, and/or other types of data (and/or data structures) suitable for use as described herein.

Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. Such instructions often improve the efficiencies and/or performance of the processor 202 that is performing one or more of the various operations herein. It should be appreciated that the memory 204 may include a variety of different memories, each implemented in one or more of the functions or processes described herein.

In the exemplary embodiment, the computing device 200 includes a presentation unit 206 that is coupled to (and in communication with) the processor 202 (however, it should be appreciated that the computing device 200 could include output devices other than the presentation unit 206, etc.). The presentation unit 206 outputs information (e.g., product purchase interfaces, etc.), visually, for example, to a user of the computing device 200 such as the consumer 114 in the system 100, etc. It should be further appreciated that various interfaces (e.g., as defined by web-based applications, websites, etc.) may be displayed at computing device 200, and in particular at presentation unit 206, to display certain information. The presentation unit 206 may include, without limitation, a liquid crystal display (LCD), a light-emitting diode (LED) display, an organic LED (OLED) display, an “electronic ink” display, speakers, etc. In some embodiments, presentation unit 206 includes multiple devices. The computing device 200 also includes an input device 208 that receives inputs from the user (i.e., user inputs) such as, for example, selections to connect to a social network or take actions at the social network (to “like” a product and/or merchant, etc.), etc. The input device 208 is coupled to (and in communication with) the processor 202 and may include, for example, a keyboard, a pointing device, a mouse, a stylus, a touch sensitive panel (e.g., a touch pad or a touch screen, etc.), another computing device, and/or an audio input device. Further, in various exemplary embodiments, a touch screen, such as that included in a tablet, a smartphone, or similar device, behaves as both a presentation unit and an input device.

In addition, the illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to one or more different networks, including the network 112. Further, in some exemplary embodiments, the computing device 200 includes the processor 202 and one or more network interfaces incorporated into or with the processor 202.

Referring again to FIG. 1, the system 100 includes a discount engine 118, which is specifically configured, by executable instructions, to perform one or more of the operations herein. The discount engine 118 is illustrated in the system 100 as apart from the merchant 102 and the payment network 106. But as indicated by the dotted lines, the discount engine 118 may be incorporated with either the merchant 102 or the payment network 106. In addition, in still other embodiments, the engine 118 may be incorporated with other parts of the system 100 (e.g., the acquirer 104, the issuer 108, etc.). In general, the engine 118 may be implemented and/or located, based on, for example, a host of one or more virtual sales platforms for the merchant 102, etc.

As can be seen, the discount engine 118 is configured to perform certain operations directed to the merchant 102, and other operations directed to the consumer 114. In general, the discount engine 118 integrates, at least partially, with the sales platform for the merchant 102, and in particular, the virtual sales platform (e.g., the website(s), mobile application(s), etc.), for the merchant 102. As indicated above, the sales platform for the merchant 102 is hosted by the payment network 106 in system 100. The sales platform permits the merchant 102 to add products, remove products, track product sales, manage payments/receipts, and/or perform other operations to facilitate sales of products to consumer 114 and to other consumers in the system 100, etc.

In addition to the above, the discount engine 118 (as part of the merchant's virtual sales platform) is also uniquely configured to permit the merchant 102 to create one or more social network campaigns for the merchant's products. Such social network campaign(s), broadly, is an offer from the merchant 102 to discount a product, when the consumer 114 takes a certain social network action (e.g., “like” the product offered by the merchant 102, “like” the merchant 102, etc.). In particular, the merchant 102 is registered to the discount engine 118, often as part of registering for the sales platform, at the payment network 106, to offer one or more products for sale. In connection with registration, the merchant 102 is provided credentials, which permit the merchant 102 (or more specifically, employees, managers, etc. of the merchant 102) to access a merchant management tool of the sales platform. Through the tool, then, the merchant 102 is able to create a social network campaign (e.g., select an option to create the social network campaign, etc.). In response, the discount engine 118 is configured to cause one or more interfaces to be displayed to the merchant 102, via the merchant management tool, through which the campaign is created and launched.

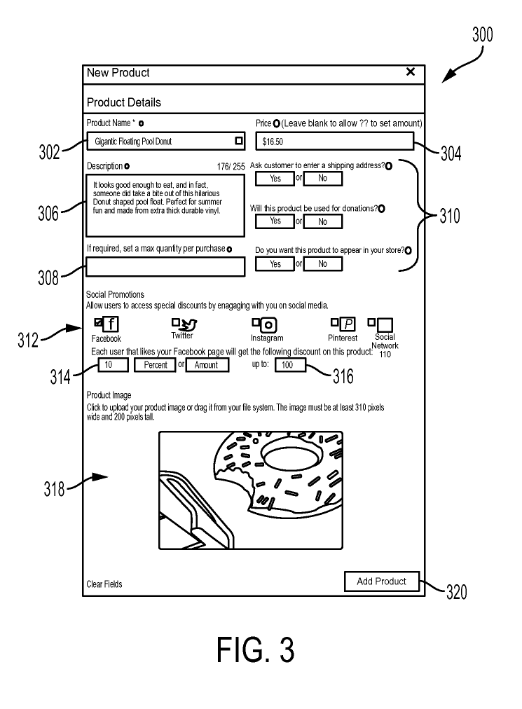

FIG. 3 illustrates an exemplary campaign interface 300 that may be displayed to the merchant 102, by the discount engine 118, to create (and launch) a social network campaign. As shown in FIG. 3, the campaign interface 300 generally includes multiple fields to enter and/or select parameters of the campaign, including a field 302 that permits the merchant 102 to enter the name of the product for the campaign (i.e., a product offered for sale through the merchant's virtual sales platform), a field 304 to enter a price of the product, a field 306 to enter a description of the product, and a field 308 to designate a maximum number of purchases of the product that can be made by a single consumer. The campaign interface 300 also includes a section 310 at which additional details of the campaign relating to, for example, display of the product in the merchant's virtual store front, designation of the product as a gift/donation, and entry of shipping addresses by consumers upon purchase can be set by the merchant 102.

The illustrated campaign interface 300 also generally includes options 312 for the merchant 102 to select one or more social networks (e.g., social network 110, etc.) for participation in the campaign. That is, the campaign may be limited to only one social network, or may be active for multiple social networks. In one example, the merchant 102 may select particular social networks, for particular products, potentially based on the merchant's perception of to which social network likely consumers of the product may be active members The merchant 102 can then enter a discount in an amount of the product, or a percent off the product price (e.g., 10% off, $5 off, etc.), at field 314, and an allotted number of discounts for the campaign (e.g., 100, 150, 1000, etc.) at field 316 (all broadly, parameters of the campaign, etc.). Further, when desired, the merchant 102 can upload an image of the product (or products), to which the campaign applies or is directed, to the campaign interface 300 (for use by the discount engine 118) at field 318. Button 320 then allows the merchant 102 to launch the campaign, once the merchant 102 provides the requested information to the interface 300 as described above.

In other exemplary embodiments, campaign interfaces may include additional and/or different fields providing additional and/or different data to the merchant 102 for review/consideration/entry when creating social network campaigns. In addition, different parameters of campaigns related to products and/or product discounts may be incorporated in different interfaces, for example, for different campaigns. Further, it should be appreciated that the fields and/or arrangements of the fields may be different in other interfaces than illustrated in the exemplary interface 300 of FIG. 3.

With reference again to FIG. 1, after a social network campaign for a product is created and launched by the merchant 102 to the social network 110, via the discount engine 118, the consumer 114 (and other consumers) can select the product at the merchant's virtual sales platform and/or select a link included in an email, instant message, social network post, etc., either directed to the consumer 114, or in general, that is associated with the product and/or the merchant 102. In turn, the discount engine 118 is configured to cause a product purchase interface to be displayed to the consumer 114 (at communication device 116), which includes an option for the consumer 114 to connect to (e.g., login to, etc.) the social network 110. When the consumer selects the connect option, the discount engine 118 is configured to direct the consumer 114, via one or more interfaces, to provide login credentials for the social network 110 (in this embodiment, the consumer has already “liked” the product). Then, the discount engine 118 is configured to call the API associated with the social network 110 to verify the consumer 114 has “liked” the product. In turn, the discount engine 118 is configured to present a product purchase interface in which the discount is applied, when the “like” for the consumer 114 is verified, whereby the consumer 114 is then able to purchase the product at the discounted price (e.g., a normal product price less a campaign discount, etc.).

The purchase of the product, via the product purchase interface, is then permitted to proceed, through the merchant's virtual sales platform, i.e., to the merchant 102, with the consumer 114 providing payment account information, etc., in connection with a typical purchase transaction as described above.

The following is an exemplary code section that includes exemplary instructions that configure the discount engine 118 to permit a consumer (e.g., consumer 114) to provide login credentials for a social network, specifically, in this example, a Facebook® social network, etc.

```
$scope.login = function ( ) {
  ezfb.login(function (res) {
    if (res.authResponse) {
      //updateLoginStatus(confirmLikes);
      $scope.facebookLikeConfirmed = true;
      updateLoginStatus(applyDiscount);
    }
  }, {scope: 'email,user_likes'});
};
function updateLoginStatus (more) {
  ezfb.getLoginStatus(function (res) {
      $scope.loggedIn = !!(res.status === “connected”);
      $scope.accessToken = res.authResponse.accessToken;
      $scope.userID = res.authResponse.userID;
      (more || angular.noop)( );
  });
}
```

And, the following is an exemplary code section that includes exemplary instructions that configure the discount engine 118 to confirm, via an API to the Facebook® social network, in this example, to verify a “like” action by a consumer and apply an appropriate discount to the consumer upon purchase of a particular product associated with the “like” action.

```
function confirmLikes( ) {
  var postID = $scope.firebaseData.postID.split('_')[0];
  ezfb.api($scope.userID + '/likes', {access_token : $scope.
  accessToken},
function (res) {
    console.log(“Posts that user” + $scope.userID +
    “ liked: ”, res);
    angular.forEach(res.data, function(item) {
      if(item.id === postID) {
      $scope.facebookLikeConfirmed = true;
      applyDiscount( );
      }
    });
  });
  }
  function applyDiscount( ) {
    $scope.products.oldPrice = $scope.products.price;
    if($scope.products.socialDiscount.amountOff){
      $scope.products.price = $scope.products.oldPrice -
$scope.products.socialDiscount.amountOff;
    }
    else if($scope.products.socialDiscount.percentOff){
    $scope.products.price = $scope.products.oldPrice -
($scope.products.oldPrice * ($scope.products.socialDiscount.
percentOff / 100))
    }
  }
```

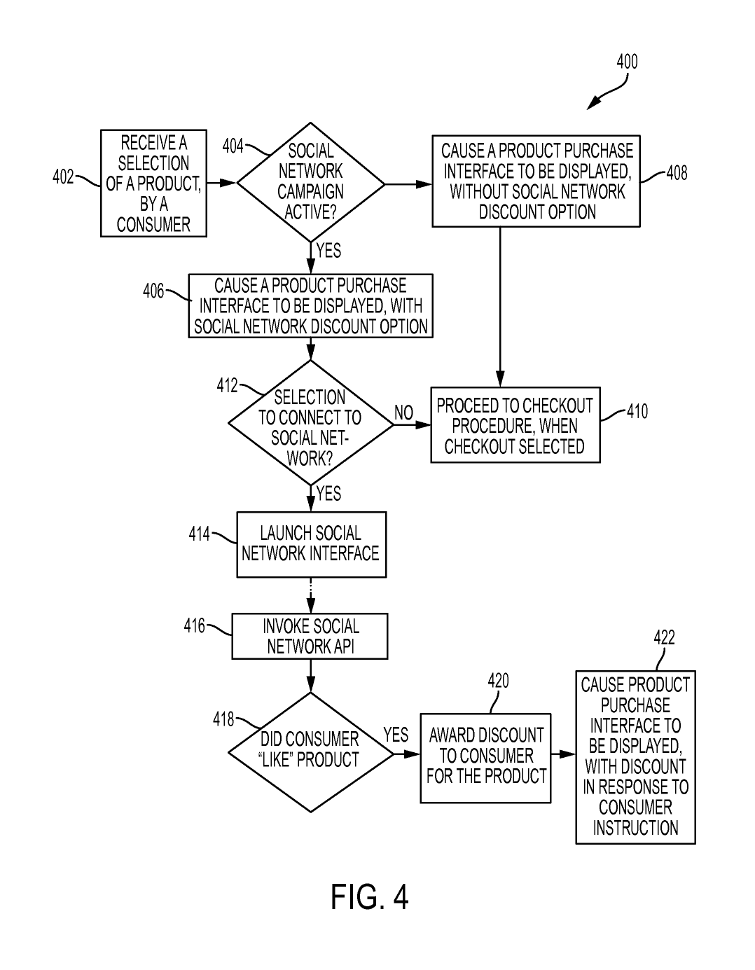

FIG. 4 illustrates an exemplary method 400 for linking a product discount to a social network, and to an action by a consumer at the social network, for example, as part of a social network campaign. The exemplary method 400 is described as implemented in the discount engine 118 of system 100, and the portable communication device 116 associated with consumer 114. However, it should be understood that the method 400 is not limited to this configuration, as the method 400 may be implemented in other ones of the computing devices 200 in system 100, or in multiple other computing devices. As such, the methods herein should not be understood to be limited to the exemplary system 100 or the exemplary computing device 200, and likewise, the systems and the computing devices herein should not be understood to be limited to the exemplary method 400.

After a social network campaign is created by the merchant 102, via the discount engine 118, as described above, the discount engine 118 may optionally disseminate messages to certain consumers (e.g., consumer 114, etc.), who have previously purchased products from the merchant 102 (e.g., who are on a distribution list, who have voluntarily provided contact information to the merchant 102, etc.), or who are generally known to the merchant 102, etc. In one example, when a campaign is created by the merchant 102 for a product, the discount engine 118 disseminates a product offer (or other social network content), via social network 110 or by other means (e.g., via email, SMS message, instant message, etc.), to consumers inviting the consumers to purchase the product and to receive a campaign defined discount. Often, the manner in which the offer is disseminated is based on the types of contact information available for the consumers to the discount engine.

In the method 400, the consumer 114, and other consumers supported by the system 100, are followers of the merchant's social network page at the social network 110. As such, when the merchant 102 launches a social network campaign, the consumer 114 may (or may not) be contacted through the social network 110, via a post disseminated to the merchant's followers.

As an example, in some certain social networks (e.g., the Twitter® social network, etc.), when the consumer 114 is a follower of the merchant 102, a message is appended, by the social network, to the consumer's social network page regarding the merchant's social network campaign (and optionally including a link to the product at the merchant's sales platform). Alternatively, or additionally, in other social networks (e.g., the Facebook® social network, etc.), even though the consumer 114 may be a follower of the merchant 102, posts (or other social network content) generated by the merchant 102 may only be disseminated to the consumer 114 by the social network under certain conditions (e.g., only if the consumer approves receipt of such posts, etc.). Here, if the merchant's posts are not disseminated by the social network to the consumer 114, the consumer 114 may instead learn of the merchant's campaign (and view the merchant's product post and discount offer) by visiting and/or viewing the merchant's page at the social network. It should be appreciated that even in the social networks where the merchant's product campaign is disseminated to the consumer 114, merely based on the merchant's post (and the consumer 114 following the merchant 102), the consumer 114 often is still able to view the product (and associated campaign discount) at the merchant's page at the given social network. In addition, in some embodiments, the merchant 102 may cause, via a service offered by one of the social networks, the product and discount to be disseminated with the social network to all or certain users, including users not following the merchant 102, etc. Further, in various embodiments, the manner in which a social network campaign (and associated campaign product) is disseminated in a social network to consumers/users may be based, for example, on the particular social network and the operation thereof.

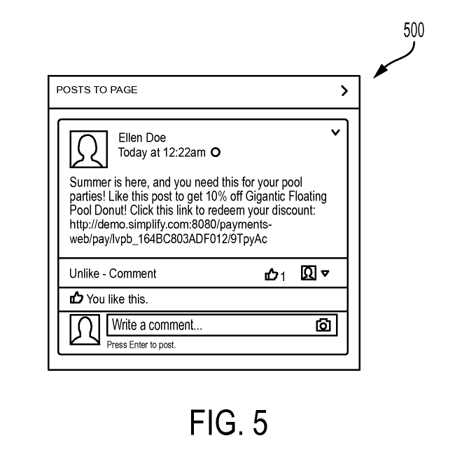

FIG. 5 illustrates an exemplary message 500 that may be transmitted from the social network 110 to the consumer 114 in the method 400 (e.g., appended, by the social network, to the consumer's social network page, etc.), and specifically to the consumer's communication device 116, regarding the merchant's social network campaign. As shown, the message includes the name and description of the product associated with the campaign and the discount offered by the merchant 102 through the campaign, as well as a link to the product at the merchant's virtual sales platform, for example. It should be appreciated that the consumer 114, or other consumers, may be informed of the campaign in one or more other manners, through the social network 110 or otherwise, even if the consumer 114 (or other consumers) is/are not followers to the merchant's social network page.

With reference again to FIG. 4, after the consumer 114 is notified of the merchant's social network campaign, the discount engine 118 waits for the consumer 114 (or other consumers) to select the product to which the campaign is directed. As described above, the consumer 114 may be notified of the campaign either at the merchant's virtual sales platform via a link (or via other social network content) disseminated by the merchant 102 (or by the social network 110) as illustrated in FIG. 5, or otherwise. Additionally, or alternatively, the merchant 102 may notify the consumer 114 (and other consumers) via the social network 110 (and/or one or more other social networks), via SMS, via email, via blog or other content marketing, via print or other advertising, via word of mouth, etc. In any case, it should be appreciated that notifications, when separate from the social network 110, for example, may include additional information to inform the consumer 114 how to redeem the discount associated with the campaign. For example, a notification message may indicate “‘Like’ our Facebook® page and check it for new product offers. Your friends can ‘like’ our page and get discounts, too!” In addition, it the particular content and/or form of the notifications may vary in numerous other embodiments, so long as the associated messages are informative of the products and the discounts provided for one or more social network actions.

Upon selection of the product by the consumer 114, either at the merchant's virtual sales platform or otherwise, the discount engine 118 receives the selection, at 402, and determines if the merchant's social network campaign is active, at 404. For example, the discount engine 118 may inquire with the merchant 102 to determine if the campaign is active (e.g., if the campaign has started, if the campaign has expired, etc.). Or, the discount engine 118 may retrieve/access parameters for the campaign associated with its duration (e.g., as provided by the merchant 102 when creating and launching the campaign, etc.) such as, for example, specific dates for the campaign, transaction (or redemption) limitations for the campaign (e.g., allotted numbers of discounts, etc.), etc. For example, the discount engine 118 may determine, at 404, if the allotted number of discounts, as defined by the merchant 102, has been used. Specifically, as long as the allotted number of discounts is greater than a number of discounts for the product currently redeemed by consumers, the discount engine 118 determines the campaign is still active. Conversely, when the current number of redeemed discounts for the product reaches the allotted number of discounts, the discount engine 118 determines the campaign to be no longer active (i.e., it is expired).

When the merchant's social network campaign is active at 404, the discount engine 118 causes, at 406, a product interface (e.g., an offer product interface, etc.) to be displayed to the consumer 114, and specifically, at the communication device 116. The product interface identifies the product selected by the consumer 114 (and associated with the active campaign), and includes a purchase price of the product (e.g., a normal purchase price of the product, an undiscounted purchase price of the product, etc.) if the consumer 114 desires to purchase the product without taking further action.

However, when the merchant's social network campaign is not active at 404, the discount engine 118 causes, at 408, a product purchase interface to be displayed to the consumer 114, and specifically, at the consumer's communication device 116. The product purchase interface identifies the product selected by the consumer 114, and includes the purchase price of the product. The product purchase interface also includes an option for the consumer 114 to purchase the product (or broadly, checkout). When the consumer 114 selects the purchase option (or selects to checkout) at the product purchase interface, the discount engine 118 initiates a purchase transaction to the payment account associated with the consumer 114 for the normal purchase price of the product, at 410, through the merchant's virtual sales platform, i.e., to the merchant 102, with the consumer 114 providing payment account information, etc., in connection with a typical purchase transaction (as described above).

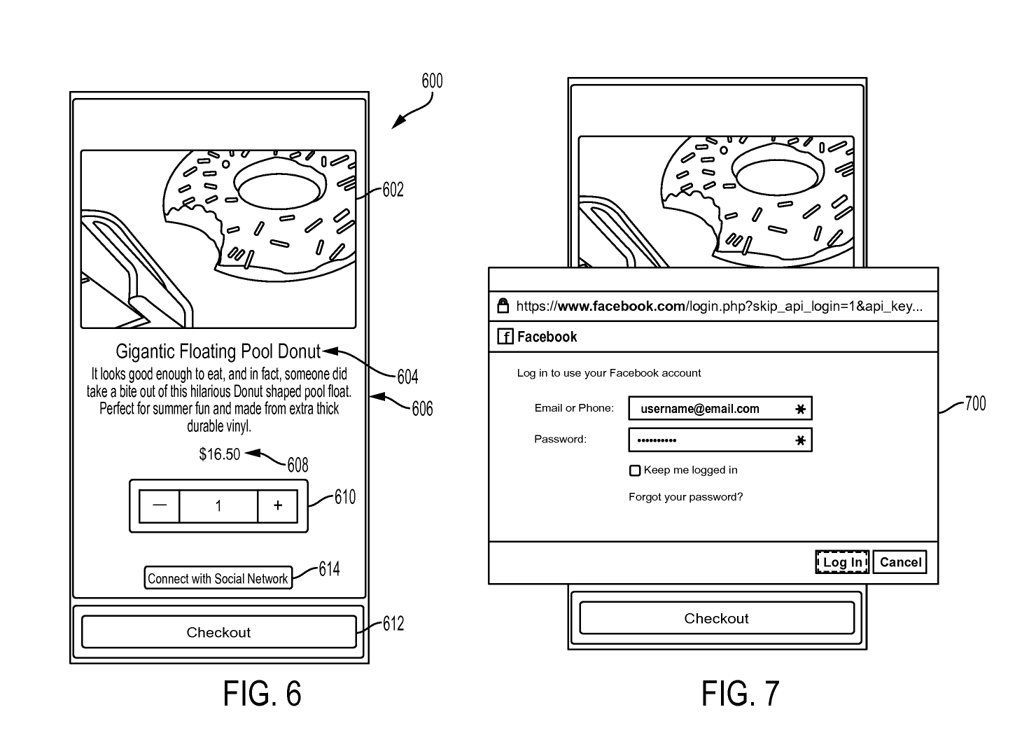

FIG. 6 illustrates an exemplary product interface 600 that may be displayed by the discount engine 118 to the consumer 114 (at operation 406), when a campaign by the merchant 102 is determined to be active. The product interface 600 generally includes an image 602 of the product selected by the consumer 114 and associated with the campaign (e.g., the image of the product uploaded by the merchant 102 when creating the campaign, etc.), a name 604 of the product (i.e., Gigantic Floating Pool Donut), a description 606 of the product, and a normal price 608 of the product (i.e., $16.50). The product interface 600 also includes a field 610 for the consumer 114 to select a number of products to purchase, and a button 612 to checkout (e.g., to purchase the selected product(s), etc.) as desired. Upon selection of the checkout button 612, the consumer 114, is prompted by the discount engine 118 to enter certain payment account information to initiate purchase of the product, as is conventional, and then confirm the purchase.

In other exemplary embodiments, product interfaces may include additional and/or different fields providing additional and/or different data to the consumer 114 relating to the social network campaigns. In addition, it should be appreciated that the fields and/or arrangements of the fields may be different in other interfaces than illustrated in the exemplary interface 600 of FIG. 6. Further, it should also be appreciated that the product purchase interface displayed to the consumer 114 at operation 408 in the method 400, when a campaign by the merchant 102 is determined to be expired, may be similar to the interface 600 in some embodiments.

Referring again to FIG. 4, the product interface displayed to the consumer 114 at 406 also includes an option for the consumer 114 to connect to (e.g., login to, etc.) the social network 110 and take appropriate action to qualify for the product discount associated with the merchant's social network campaign. When the discount engine 118 receives a selection by the consumer 114, to the product interface, at 412, to connect to the social network 110, the discount engine 118 then launches an interface for the social network 110, at 414. The interface generally includes a login option for the consumer 114, into which the consumer is permitted to enter credentials to log onto his/her account at the social network 110. As an example, the product interface 600 of FIG. 6 includes a button 614 to connect to a social network (e.g., a predetermined social network such as social network 110, a social network selected from different available options through button 614 or a duplicate thereof, etc.). Then, when the button 614 is selected by the consumer 114 to connect to the desired social network 110, the discount engine 118 causes a social network interface associated with, and/or provided by, the social network to be displayed at the consumer's communication device 116, through which the consumer 114 is permitted to provide login credentials.

FIG. 7 illustrates an exemplary social network interface 700 that may be displayed by the discount engine 118 (or the social network 110, or combination thereof) to the consumer 114 to permit the consumer 114 to receive the consumer's credential for the social network 110.

It should be appreciated that when the merchant 102 opts to include multiple social networks in a social network campaign (e.g., at option 312 in the campaign interface 300 of FIG. 3, etc.), the discount options presented to the consumer 114 (for selection at operation 412) may include a separate discount option button for each social network, or another manner of selection, by which the consumer 114 is able to select the social network for which to provide credential and/or through which of the multiple social networks to take a necessary action related to the product. The consumer 114 may select one of the social networks, or multiple ones of the social networks. As described above, upon selection, the consumer 114 is then able to provide login credentials for the selected social network(s), for example, by entry to the interface 700 of FIG. 7. As should be apparent, the subsequent aspects of method 400, where necessary, are specific to the social network 110 as associated with the discount option selected by the consumer 114 at 412.

After the consumer 114 has submitted his/her credentials to the social network 110, the discount engine 118 uses the consumer's login credentials and invokes a social network API, at 416. For example, the discount engine 118 calls the API associated with the social network 110 (i.e., the social network 110 associated with the consumer's selected discount option at operation 412), and provides specific credentials and/or permissions to access the social network profile provided by the consumer 114. In one or more embodiments, an interface is further displayed to the consumer 114, which requests the consumer 114 to confirm permission to access the consumer's social network account.

The discount engine 118 then determines (or verifies), at 418, whether or not the consumer 114 has taken the appropriate social network action at the social network 110 to obtain the product discount associated with the merchant's social network campaign.

When the discount engine 118 determines that the consumer 114 has taken the appropriate social network action at the social network 110, at 418, it awards the product discount (or campaign discount) to the consumer 114 for the product, at 420. In turn, the discount engine 118 causes a discount product purchase interface (broadly, a product interface) to be displayed to the consumer, at 422. Much like the product purchase interface displayed to the consumer 114 at operation 408 (e.g., the product purchase interface 600 of FIG. 6, etc.), the discount product purchase interface identifies the product selected by the consumer 114 (as received by the discount engine 118 at 402), and includes a purchase price of the product (e.g., a normal purchase price of the product, an undiscounted purchase price of the product, etc.) and the discount awarded by the discount engine 118 (i.e., a discounted purchase price). The product purchase interface then also includes an option for the consumer 114 to purchase the product and checkout. When the consumer 114 selects the purchase option (or selects to checkout) at the discount product purchase interface, the discount engine 118 initiates a purchase transaction to the payment account associated with the consumer 114 for the discounted purchase price of the product (e.g., the normal product price less the campaign discount, etc.) through the merchant's virtual sales platform, i.e., to the merchant 102, with the consumer 114 providing payment account information, etc., in connection with a typical purchase transaction (as described above).

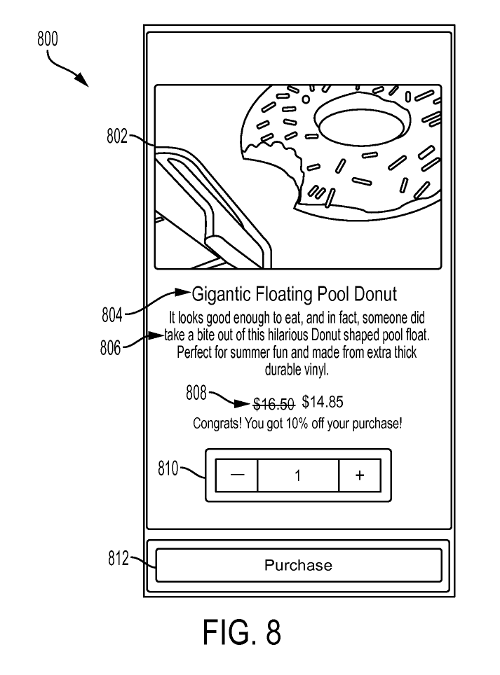

FIG. 8 illustrates an exemplary discount product purchase interface 800 that may be displayed by the discount engine 118 to the consumer 114 (at operation 422). The discount product purchase interface 800 generally includes an image 802 of the product selected by the consumer 114 and associated with the campaign (e.g., the image of the product uploaded by the merchant 102 when creating the campaign, etc.), a name 804 of the product (i.e., Gigantic Floating Pool Donut), a description 806 of the product, and a discount price 808 of the product (i.e., $14.85). The discount product purchase interface 800 also includes a field 810 for the consumer 114 to select a number of products to purchase, and a button 812 to checkout (e.g., to purchase the selected product(s), etc.) as desired. Upon selection of the checkout button 812, the consumer 114, is prompted by the discount engine 118 to enter certain payment account information to initiate purchase the product, as is conventional (and as described above), and in some embodiments to also confirm the purchase.

Optionally, although not necessarily, when the consumer 114 selects to connect to the social network 110, at 412, after providing his/her credentials to login, the consumer 114 may be directed to a product interface associated with the merchant's product, which is displayed at the consumer's communication device 116. When the consumer 114 has not previously taken action regarding the product in the social network 110, the product interface permits the consumer 114 to take one or more social network actions related to the product (e.g., “like” the product, “like” the merchant 102, comment on the product or merchant 102, or even “dislike” a product and/or merchant, etc.). After which, the social network API may be invoked, by the discount engine 118, to proceed as described above.

Further in the method 400, when the discount engine 118 does not receive a selection by the consumer 114 to connect to the social network 110, at 412 (e.g., after a predefined time period, etc.), or receives an instruction from the consumer 114 to simply purchase the product without connecting to the social network 110 (e.g., via selection of button 612 in product interface 600, etc.), the discount engine 118 initiates a purchase transaction to the payment account associated with the consumer 114 for the normal purchase price of the product, at 410, in connection with a typical purchase transaction (as described above). Because the consumer 114, at this point in the method 400 has not yet taken any social network action toward the product associated with the merchant's social network campaign (e.g., “liked” or “disliked” the merchant's product, etc.) at social network 110, the product price is still the full product price without any discount applied.

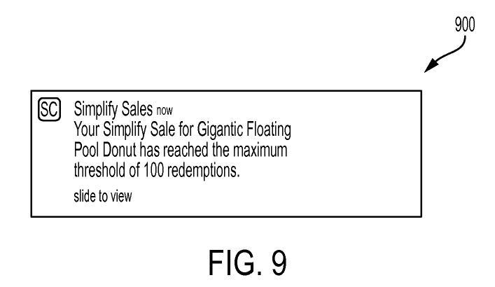

At different times and/or intervals after creating the social network campaign, the merchant 102 may opt to receive status messages from the discount engine 118 regarding the campaign. For example, when the merchant's social network campaign ends (or expires), the discount engine 118 may transmit a notification to the merchant 102 indicating that the campaign has concluded. In this example, the merchant 102 may specify a particular time frame for the campaign (e.g., January 1 to February 1, etc.), or the merchant 102 may specify that the campaign will be active for an allotted number of discounts (e.g., 100, 150, 1000, etc.). Then, when the discount engine 118 determines that the time frame has expired or the allotted number of discounts has been achieved, it transmits the notification to the merchant 102. It should be appreciated that other notification may be provided from the discount engine 118, including for example, milestones (e.g., 50 of the 100 allotted discounts have been used, etc.), rates of purchases (e.g., 10 purchases have been made in the last 15 minutes, etc.), etc. In general, the merchant 102 may select notification options to govern all campaigns, or may provide for particular notifications, for example, when creating the campaign, etc. Further, it should be appreciated that the discount engine 118 can transmit the notifications to the merchant 102 by various suitable means including, for example, via email, SMS text message, etc. FIG. 9 illustrates an exemplary message 900 that may be transmitted from the discount engine 118 to the merchant 102, indicating that the merchant's social network campaign has ended. It should be appreciated that the merchant 102 may be informed that its campaign has ended in one or more other manners, for example, through the social network 110 or otherwise.

In view of the above, the systems and methods herein may permit merchants, for example, to generate product advertising between consumers, via one or more social networks. In particular, the merchants are able to introduce and drive products, via limited discounts to a number of consumers who “like” or otherwise perform social network actions related to a products, into the social networks, which, in turn, act to disseminate social network content related to the products to the consumers linked to and/or following the purchasing consumers, and so on, as the products are purchased at the discounted prices. In this manner, the merchants use the consumers to continue marketing of their products, and therefore are not only able to reach consumers who are interested in, and may purchase the products, but are also provided access to followers of those consumers, through one or multiple levels. The followers of those consumers, often by association with the purchasing consumers, are then potential purchasers and suitable targets of advertising of the products.

Again and as previously described, it should be appreciated that the functions described herein, in some embodiments, may be described in computer executable instructions stored on a computer readable media, and executable by one or more processors. The computer readable media is a non-transitory computer readable storage media. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) causing a product interface to be displayed to a consumer, in response to a selection of a product, the product interface including an offer for sale of the product at a price and at least one discount option associated with a social network action to at least one social network; (b) receiving a selection of the at least one discount option; (c) verifying via an application programming interface (API) associated with the at least one social network, the social network action for the product within said at least one social network; (d) awarding a discount associated with the discount option to the consumer for the product, when the social network action is verified, whereby the consumer is able to purchase the product for the price of the product less the awarded discount; (e) determining whether an allotted number of discounts is satisfied prior to causing the product purchase interface to be displayed to the consumer; and (f) initiating a transaction to a payment account associated with the consumer, for the price of the product less the discount associated with the discount option, in response to a purchase instruction from the consumer.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

In addition, as used herein, the term product may include a good and/or a service.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in linking product offers to social network actions, the method comprising:
causing a product interface to be displayed to a consumer in response to a selection of a product, the product interface including an offer for sale of the product, by a merchant, at a price and at least one discount option for the product associated with a social network action to at least one social network;
receiving a selection of the at least one discount option;
verifying, by a computing device, via an application programming interface (API) associated with the at least one social network, the social network action for the product within said at least one social network;
awarding, by the computing device, a discount associated with the at least one discount option to the consumer for the product, when the social network action is verified, whereby the consumer is able to purchase the product for the price of the product less the awarded discount.

2. The computer-implemented method of claim 1, wherein the discount is defined by a social network campaign related to said product, the social network campaign including an allotted number of discounts; and
further comprising determining whether the allotted number of discounts is satisfied prior to causing the product interface to be displayed to the consumer.

3. The computer-implemented method of claim 2, further comprising causing at least one interface associated with the at least one social network to be displayed, in response to receiving the selection of the at least one discount option, whereby the consumer is permitted to input login credentials associated with the at least one social network; and
wherein verifying the social network action includes invoking the API associated with the at least one social network, based, at least in part, on the login credentials input by the consumer, after causing the at least one interface associated with the social network to be displayed.

4. The computer-implemented method of claim 1, wherein awarding the discount to the consumer includes causing a discount product purchase interface to be displayed to the consumer, said discount product purchase interface including at least two of: the price of the product, the discount, and/or the price of the product less the discount.

5. The computer-implemented method of claim 4, wherein the social network action includes a “like” of said product within the social network, whereby a social network content associated with the product is disseminated to at least one follower of the consumer in the social network.

6. The computer-implemented method of claim 5, further comprising initiating a transaction to a payment account associated with the consumer, for the price of the product less the awarded discount, in response to a purchase instruction from the consumer, at the product interface.

7. The computer-implemented method of claim 1, further comprising:
receiving the selection of the product, at a web-based platform associated with the merchant;
determining if a social network campaign is active for the product; and
when the social network campaign is active for the product, causing the product interface to be displayed to the consumer in response to the selection of the product.

8. The computer-implemented method of claim 1, wherein the at least one discount option includes a first discount option associated with the social network and a second discount option associated with a different social network; and
wherein verifying via the API associated with the at least one social network includes verifying via the API associated with the at least one social network when the first discount option is selected; and
further comprising verifying, by the computing device, via a different API associated with the different social network, the social network action for the product within said different social network, when the second discount option is selected.

9. The computer-implemented method of claim 8, wherein awarding the discount to the consumer includes modifying the product interface to:
include the price of the product less the awarded discount; and
omit the discount option.

10. A system for use in linking social network actions related to products to discounts for said products, the system comprising:
at least one computing device for communicating with at least one social network via an application programming interface (API) for the social network, the social network including content associated with a merchant and related to a product, the at least one computing device configured to:
invoke the API for the social network, based on at least one credential for a consumer;
verify a “like” social network action directed to the product, by the consumer, in the social network; and
cause a product interface associated with the product to be displayed to a consumer, when the “like” social network action is verified, the product interface offering the product for purchase at a discounted price, whereby the consumer is permitted to purchase the product at the discounted price in exchange for the social network action in the social network.

11. The system of claim 10, wherein the at least one computing device is further configured to cause a social network interface to be displayed to the consumer, at a communication device associated with the consumer, and to receive the at least one credential for the consumer via the social network interface.

12. The system of claim 10, wherein the at least one computing device is configured to invoke the API for the social network, in response to a selection of a discount option in an offer product interface, at a communication device associated with the consumer.

13. The system of claim 10, wherein the at least one computing device is further configured to cause a campaign interface to be displayed at a computing device associated with the merchant and to receive, via the campaign interface, at least one campaign parameter from the merchant.

14. The system of claim 13, wherein the at least one campaign parameter includes: an allotted number of discounts, a discount associated with the discount price, and an identification of at least the social network in which the “like” social network action is to be taken by the consumer in order for the consumer to be awarded the discount.

15. A non-transitory computer-readable media including executable instructions for linking a discount for a product to a social network action related to the product, which, when executed by at least one processor, cause the at least one processor to:
cause a product interface to be displayed at a communication device associated with a consumer, the product interface including at least two of a product name of a product, a product price of the product, and a discount option for the product based on a social network action by the consumer;
after selection, by the consumer, of the discount option, receive social network credentials for the social network for the consumer;
invoke an API associated with the social network, based on, at least in part, the social network credentials;
verify, via the API associated with the social network, the consumer's social network action, at the social network, related to the product; and
modify the product interface to include a discounted price for the product, but not the discount option, when the social network action is verified.

16. The non-transitory media of claim 15, wherein the executable instructions, when executed by the at least one processor, cause the at least one processor, in order to cause the product interface to be displayed at the communication, to send a SMS message to the communication device; and
wherein the SMS message includes the product name, the product price, and at least one of: a product discount associated with the discount option and/or the discounted price for the product.

17. The non-transitory media of claim 15, wherein the executable instructions, when executed by the at least one processor, cause the at least one processor to generate a campaign for the product, based on at least one parameter received from the merchant, the at least one parameter defining a discount for the product associated with the discount option.

18. The non-transitory media of claim 17, wherein the at least one parameter further defines an allotted number of discounts for the product; and
wherein the executable instructions, when executed by the at least one processor, cause the at least one processor to cause the product interface to be displayed at the communication device associated with the consumer, in response to a consumer selection, when the allotted number of discounts is greater than a number of redeemed discounts for the product.

19. The non-transitory media of claim 18, wherein the campaign is applicable to the social network and an additional social network; and
wherein the product interface includes an additional discount option for the product based on a social network action by the consumer at the additional social network; and
wherein the executable instructions, when executed by the at least one processor, cause the at least one processor to
after selection, by the consumer, of the additional discount option, receive social network credentials for the additional social network for the consumer;
invoke an API associated with the additional social network, based on, at least in part, the social network credential for the additional social network;
verify, via the API associated with the additional social network, the consumer's social network action, at the additional social network, related to the product; and
modify the product interface to include a discounted price for the product, but not the additional discount option, when the social network action at the additional social network is verified.

20. The non-transitory media of claim 15, wherein the social network action includes a “like” of said product on the social network, whereby a social network content related to the product is disseminated to one or more followers of the consumer.
